(19) United States
(12) Patent Application Publication
(10) Pub. No.: US 2026/0188331 A1
(43) Pub. Date: Jul. 2, 2026

(54) ADAPTIVE STEREO PARAMETER SYNTHESIS

(71) Applicant: Telefonaktiebolaget LM Ericsson (publ), Stockholm (SE)

(72) Inventors: Tomas JANSSON TOFTGÅRD, UPPSALA (SE); Fredrik JANSSON, SUNDBYBERG (SE)

(73) Assignee: Telefonaktiebolaget LM Ericsson (publ), Stockholm (SE)

(21) Appl. No.: 19/131,964

(22) PCT Filed: Sep. 13, 2023
(86) PCT No.: PCT/EP2023/075086

§ 371 Date: May 22, 2025

Related U.S. Application Data
(60) Provisional application No. 63/406,127, filed on Sep. 13, 2022.

(51) Int. Cl. G10L 19/008; H04S 7/00

(52) U.S. Cl. CPC G10L 19/008; H04S 7/30; H04S 2420/03

(57) ABSTRACT

A method to adjust at least one stereo parameter in a decoder is disclosed. The disclosed method includes receiving encoded stereo signals and at least one encoded stereo parameter, wherein the encoded stereo signals includes a first type of stereo signals encoded in a first encoding mode and a second type of stereo signals encoded in a second encoding mode. The method further includes processing the encoded stereo signals on a frame-by-frame basis, decoding the encoded stereo signals encoded in the first encoding mode to produce a first set of decoded stereo signals, and synthesizing stereo signals based on the first set of decoded stereo signals. The method also includes decoding the encoded stereo signals encoded in the second encoding mode and the at least one encoded stereo parameter, determining at least one designated stereo parameter based on the at least one decoded stereo parameter and an indicator indicating whether or not foreground signals and background signals are efficiently separated in the first encoding mode, and synthesizing stereo signals encoded in the second encoding mode based on the at least one designated stereo parameter.

### CROSS-REFERENCE TO RELATED APPLICATIONS

This application claims the priority benefit of U.S. Provisional Patent Application Ser. No. 63/406,127, filed Sep. 13, 2022, the disclosure of which is incorporated herein by reference in its entirety.

### TECHNICAL FIELD

The present disclosure relates generally to communications, and more particularly to communication methods and related devices and nodes supporting encoding and decoding.

### BACKGROUND

In communications networks, there may be a challenge to obtain good performance and capacity for a given communications protocol, its parameters and the physical environment in which the communications network is deployed.

For example, although the capacity in telecommunication networks is continuously increasing, it is still of interest to limit the required resource usage per user. In mobile telecommunication networks, less required resource usage per call means that the mobile telecommunication network can service a larger number of users in parallel. Lowering the resource usage also yields lower power consumption in both devices at the user-side (e.g., terminal devices) and devices at the network-side (e.g., network nodes). This translates to energy and cost saving for the network operator, while enabling prolonged battery life and increased talk-time for the terminal devices.

One mechanism for reducing the required resource usage for speech communication applications in mobile telecommunication networks is to exploit natural pauses in the speech. For example, in most conversations only one party is active at a time, and thus pauses in speech occurring in one communication direction will typically occupy more than half of the signal. One way to utilize this property to decrease the required resource usage is to employ a Discontinuous Transmission (DTX) system, where the active signal encoding is discontinued during speech pauses.

Typically, the encoding process is performed on the audio signal segments (e.g., referred to as frames) where input audio samples during a time interval, typically 10-20 milliseconds (ms), are buffered and used by an encoder to extract the parameters to be transmitted to a decoder.

During speech pauses, it is common to transmit so called SID (silence insertion descriptor) frames at a very low bit rate encoding of the background noise to allow for a Comfort Noise Generator (CNG) system at the receiving end to fill the above-mentioned pauses with a background noise that has similar characteristics as the original noise. Notably, the CNG makes the pauses sound more natural (e.g., as compared to having completely silent speech pauses) since the background noise is maintained and not switched on and off together with the speech sounds. Complete silence in the speech pauses is commonly perceived as an annoyance and often leads to the misconception that the call has been disconnected.

A DTX system may rely on a Voice Activity Detector (VAD), which indicates to the transmitting device whether to use i) active signal encoding or ii) low rate background noise encoding. In this respect, the transmitting device might be configured to differentiate between other source types by using a (Generic) Sound Activity Detector (GSAD or SAD), which not only distinguishes speech noise from background noise but can also be configured to detect music or other signal types deemed to be relevant. A block diagram of a DTX system 100 is illustrated in FIG. 1.

In FIG. 1, input audio is received by the VAD 102, the speech/audio coder 104, and the CNG coder 106. The VAD 102 indicates whether to transmit the “high” bitrate from speech/audio coder 104 or transmit the “low” bitrate from CNG coder 106.

Communication services may be further enhanced by supporting stereo or multichannel audio transmissions. In these cases, the DTX/CNG system might also account for the spatial characteristics of the signal in order to provide a pleasant-sounding comfort noise.

A common mechanism used to generate comfort noise is to transmit information about the energy and spectral shape of the background noise in the speech pauses. This can be accomplished using a significantly lower number of bits than the regular coding of speech segments. Normally, this information is sent less frequently than in the active segments as depicted in FIG. 2 where the active segments are illustrated as active encoding (e.g., see active encoding signal 202) and the information about the energy and spectral shape of the background noise in the speech pauses are illustrated as CN encoding signaling 204.

A common feature in DTX systems is to add a “hangover period” 201 to the VAD decision as illustrated in FIG. 3. During this period, active encoding will still be used even though the VAD decision (see signal 302) is that there should not be active encoding (e.g., see active encoding signal 304). This is to avoid short segments of CNG in the middle of longer active segments, e.g., in breathing pauses in a speech utterance (e.g., see signal 306). Parameters used for CNG generation can be estimated during this period.

At the receiving side, the comfort noise is generated by creating a pseudo random signal and then shaping the spectrum of the signal with a filter based on information received from the transmitting device. The signal generation and spectral shaping can be performed in the time domain or the frequency domain.

For stereo operation, additional parameters are transmitted to the receiving side. In a typical stereo signal, the channel pair shows a high degree of similarity, or correlation. State-of-the-art stereo coding schemes exploit this correlation by employing parametric coding, where a single channel is encoded with high quality and complemented with a parametric description that enables reconstruction of the full stereo image. The process of reducing the channel pair into a single channel is called a down-mix. Similarly, the resulting channel may be referred to as the down-mix channel or mixdown channel. The down-mix procedure typically tries to maintain the energy by aligning inter-channel time differences (ITD) and inter-channel phase differences (IPD) before mixing the channels. To maintain the energy balance of the input signal, the inter-channel level difference (ILD) is also measured. The ITD, IPD and ILD are then encoded and may be used in a reversed up-mix procedure when reconstructing the stereo channel pair at a decoder. FIG. 4 and FIG. 5 show block diagrams of a parametric stereo encoder 400 and decoder 500, respectively.

In FIG. 4, time domain stereo input is received by the stereo processing and mixdown module 402. The stereo processing and mixdown module 402 processes the time domain stereo input signals and produces a mono mixdown signal and stereo parameters. The mono mixdown signal is received by the mono speech/audio encoder 404, which processes the mono mixdown signal and produces an encoded mono signal. The encoded mono signal and stereo parameters are transmitted towards a decoder such as the parametric stereo decoder 500. In some examples, the stereo parameter may be quantized in and/or by the encoder and transmitted to the decoder. Notably, the stereo parameter can be used by the decoder to decode/undo the mixdown signal (see below).

In some examples, “encoded stereo signals” might be represented by the encoded mono signal and stereo parameter(s). In FIG. 5, the encoded mono signal is received by the mono speech/audio decoder 502 which decodes the encoded mono signal and produces a mono mixdown signal. The mono mixdown signal and stereo parameters are received by the stereo processing and upmix decoder 504, which processes the mono mixdown signal and stereo parameters and produces time domain stereo output. The time domain stereo output can be stored or sent to an audio player for playback.

FIG. 6 is an illustration of a practical example of the occurrence of ITD. As illustrated in FIG. 6, if a stereo signal is captured by two microphones the distance (L1) from the source (e.g., speaker source 601) to the left microphone 602 may be different from the distance (L2) to the right microphone 604. The difference in distance will lead to a time delay between the channels, the ITD. If there are several audio sources (e.g., sources 606), these source may have different ITDs. The background noise will often be a sum of many sources and may not have one apparent ITD.

The conventional parametric approach to estimate the ITD relies on the cross-correlation function (CCF) r_{xy} which is a measure of similarity between two waveforms x[n] and y[n], and is generally defined in the time domain as

$${r}_{xy} [ τ ] = E \{ x [ n ] y [ n + τ ] \} ,$$

where τ is the time-lag parameter and E{⋅} is the expectation operator. For a signal frame of length N, the cross-correlation is typically estimated as:

$$[ τ ] = {\sum }_{n = 0}^{N - 1} x [ n ] y [ n + τ ] .$$

The Inter-channel Cross-correlation Coefficient (ICC) is conventionally obtained as the maximum of the CCF which is normalized by the signal energies as follows

$$ICC = {max}_{τ = ITD} ( \frac{{r}_{xy [ τ ]}}{\sqrt{{r}_{xx} [ 0 ] {r}_{yy} [ 0 ]}} ) .$$

The time lag τ corresponding to the ICC is determined as the ITD between the channels x and y. By assuming x[n] and y[n] are zero outside the signal frame, the cross-correlation function can equivalently be expressed as a function of the cross-spectrum of the frequency spectra X[k] and Y[k] (with discrete frequency index k) as:

$${X}_{corr} [ k ] = X [ k ] {Y}^{*} [ k ]$$

$${r}_{xy} [ τ ] = {DFT}^{- 1} ( {X}_{corr} [ k ] )$$

where X[k] is the discrete Fourier transform (DFT) of the time domain signal x[n], i.e.,

$$X [ k ] = {\sum }_{n = 0}^{N - 1} x [ n ] {e}^{- i \frac{2 π}{N} kn} , k = 0 , … , N - 1$$

and the DFT⁻¹(⋅) or IDFT(⋅) denotes the inverse discrete Fourier transform.

For the case when y[n] is purely a delayed version of x[n], the cross-correlation function is given by:

$${r}_{xy} [ τ ] = {DFT}^{- 1} ( X [ k ] {X}^{*} [ k ] {e}^{- i \frac{2 π}{N} k {τ}_{0}} ) = {r}_{xx} [ τ ] * δ ( τ - {τ}_{0} ) ,$$

where * denotes convolution and δ(τ−τ₀) is the Kronecker delta function, i.e., it is equal to one at τ₀ and zero otherwise. This means, the cross-correlation function between x and y is the delta function spread by the convolution with the autocorrelation function for x[n]. This will broaden the delta peak. For signal frames with several delay components, e.g., several speakers/talkers, there will be peaks at each delay present between the signals, and the cross correlation becomes

$${r}_{xy} [ τ ] = {r}_{xx} [ τ ] * {\sum }_{i} δ ( τ - {τ}_{i} ) .$$

The delta functions may then be spread into each other, which makes it difficult to identify the several delays within the signal frame. There are, however, generalized cross-correlation (GCC) functions that do not have this spreading. The GCC is generally defined as:

$${r}_{xy}^{GCC} [ τ ] = {DFT}^{- 1} ( ψ [ k ] X [ k ] {Y}^{*} [ k ] )$$

where ψ[k] is a frequency weighting. Especially for spatial audio, the phase transform (PHAT) has been utilized due to its robustness for reverberation in low noise environments. The phase transform is basically the absolute value of each frequency coefficient, i.e.,

$$ψ [ k ] = \frac{1}{\vert X [ k ] {X}^{*} [ k ] \vert} .$$

This frequency weighting will thereby whiten the cross-spectrum such that the power of each component becomes equal. With pure delay and uncorrelated noise in the signals x[n] and y[n], the phase transformed GCC (GCC-PHAT) becomes the Kronecker delta function δ(τ−τ₀), i.e.,

$${r}_{xy}^{PHAT} [ τ ] = {DFT}^{- 1} ( \frac{X [ k ] {X}^{*} [ k ] {e}^{- i \frac{2 π}{N} k {τ}_{0}}}{\vert X [ k ] {X}^{*} [ k ] \vert} ) = {DFT}^{- 1} ( {e}^{- i \frac{2 π}{N} k {τ}_{0}} ) = δ ( τ - {τ}_{0} )$$

The encoding process is conducted on time segments called frames, where the common lengths of these segments are 10 or 20 ms. The coding parameters, like the ITD, are estimated at the encoding side on a per frame basis and are transmitted to the decoder. It is also common to not transmit a parameter if there is no clear gain in the encoding process with using the parameter. In the ITD case, this will be when the left and right signals are more or less uncorrelated.

For the ITD, it is desirable to have an ITD estimate that does not have a small random variation on a frame-by-frame basis. One way to stabilize the estimate is to apply a low-pass filter the cross spectrum with a simple first order filter, such as:

$${X}_{corr \_ smooth} [ k , m ] = ( 1 - α ) * {X}_{corr \_ smooth} [ k , m - 1 ] + α * {X}_{corr} [ k ]$$

wherein k=frequency bin and m=frame number.

The filter coefficient α can be fixed, but it may also be adaptive. One example is to use a spectral flatness measure (sfm) calculated on the left or right input signal as the filter coefficient.

$$sfm = \frac{\sqrt[N]{{\prod }_{n = 0}^{N - 1} x ( n )}}{\frac{{\sum }_{n = 0}^{N - 1} x ( n )}{N}} = \frac{\frac{{\sum }_{n = 0}^{N - 1} ln ( x ( n ) )}{N}}{\frac{{\sum }_{n = 0}^{N - 1} x ( n )}{N}}$$

$${X}_{corr \_ smooth} [ k , m ] = ( 1 - sfm ) * {X}_{corr \_ smooth} [ k , m - 1 ] + sfm * {X}_{corr} [ k ]$$

This measure will have the range 0.0-1.0 where a higher value would indicate a flatter spectrum. Using this coefficient may improve the robustness and accuracy of the ITD estimation.

### SUMMARY

There currently exist certain challenges. At the decoder, stereo parameters, e.g., inter-channel level difference (or corresponding parameters, such as side-gain), inter-channel phase difference, inter-channel time difference, and inter-channel coherence, are synthesized as part of the stereo upmix processing.

Parametric coding techniques are typically beneficial at lower bitrates. Conversely, at high bitrates, the encoding of audio signals from a large number of audio channels may provide better quality, e.g., utilizing Mid/Side (M/S) stereo coding techniques or directly encoding the left and right audio channels.

However, for intermediate bitrates, hybrid coding techniques can be utilized, such that parametric models may be combined with the encoding of residual signals. These residual signals aim to capture the error between the input audio signals and what is described by the parametric model. Utilizing the residual signals at the decoder in this manner will provide an output that better resembles the original audio signals that are input to the encoder. However, since the bitrate is limited, quantization and lossy coding would typically also be exhibited by such residual signals. Accordingly, there are likely to be quantization errors present in the decoded audio signals.

Depending on whether or not active coding modes can efficiently separate the foreground signals and background signals with respect to the spatial properties of a stereo parameter, existing solutions may permit annoying artifacts, e.g., the perceived position of the background noise may move suddenly in the beginning of the CNG period, going from a segment of active coding utilizing a parametric coding technique with residual coding to a purely parametric CN encoding mode.

Certain aspects of the disclosure and their embodiments may provide solutions to these or other challenges. The various embodiments described herein can adapt the smoothing of stereo parameters for CNG based on whether or not the coding of active frames can efficiently separate the spatial properties of the foreground signals and background signals.

Certain embodiments may provide one or more of the following technical advantage(s). The various embodiments permit the comfort noise to be perceived by a listener to sound more natural and reduce/eliminate the most annoying effects associated with a sudden change in the spatial characteristics during CNG after switching from active coding. In particular, one avoids that the DTX starts with a segment of comfort noise colored by the active content and then, after some time, suddenly changes to a comfort noise that more closely resembles the original input noise.

A smooth, less noticeable/annoying transition of the background's spatial properties can be obtained in situations where typical coding techniques cannot sufficiently separate the background noise from the foreground sounds (e.g., speech) during active coding, e.g., when parametric coding techniques are used at low bitrates without residual coding. When the coding techniques are able to sufficiently separate background noise from foreground sounds during active coding, a sudden and less noticeable transition of the background's spatial properties is obtained.

In some embodiments, the disclosed subject matter includes a method for utilizing at least one stereo parameter to synthesize stereo signals in a decoder. For example, the disclosed method includes receiving and decoding an encoded mono downmix signal and at least one stereo parameter (e.g., a decoded stereo parameter, such as ITD_{target} as described below) and determining at least one designated stereo parameter for synthesis based on an indicator indicating whether or not foreground and background signals are efficiently separated during active coding. The method further includes synthesizing stereo signals based on the at least one designated stereo parameter for stereo synthesis (e.g., ITD_{syn} as described below) and the mono downmix signal on a frame-by-frame basis.

In some embodiments, the disclosed subject matter includes a method that comprises receiving encoded stereo signals and at least one encoded stereo parameter, wherein the encoded stereo signals includes a first type of stereo signals encoded in a first encoding mode and a second type of stereo signals encoded in a second encoding mode. The method further includes processing the encoded stereo signals on a frame-by-frame basis, decoding the encoded stereo signals encoded in the first encoding mode to produce a first set of decoded stereo signals, and synthesizing stereo signals based on the first set of decoded stereo signals. The method also includes decoding the encoded stereo signals encoded in the second encoding mode and the at least one encoded stereo parameter, determining at least one designated stereo parameter based on the at least one decoded stereo parameter and an indicator indicating whether or not foreground signals and background signals are efficiently separated in the first encoding mode, and synthesizing stereo signals encoded in the second encoding mode based on the at least one designated stereo parameter.

According to an aspect of the method described herein, wherein the decoding the encoded stereo signals encoded in a second encoding mode and the at least one stereo parameter comprises decoding an encoded mono downmix signal.

According to an aspect of the method described herein, the at least one stereo parameter comprises an inter-channel time difference (ITD).

According to an aspect of the method described herein, responsive to the indicator indicating that foreground and background signals are efficiently separated, obtaining an ITD used for stereo upmix ITD_{syn} directly from a target ITD (i.e., a decoded stereo parameter) obtained from the encoder in accordance with ITD_{syn}=ITD_{target}.

According to an aspect of the method described herein, responsive to the indicator indicating that foreground and background signals are not efficiently separated, gradually fading an ITD used for stereo upmix ITD_{syn} from the previous ITD towards ITD_{target} in accordance with:

$${ITD}_{syn} = {ITD}_{prev} + {ITD}_{step} if itd\_xfade \_counter < {L}_{xfade}$$

wherein itd_xfade_counter is a frame counter increased by one for every frame during a pause period in the mono downmix signal, L_{xfade} corresponds to a total fade length, ITDₚᵣₑᵥ keeps track of the latest ITD value of a gradual fade towards ITD_{target} and ITDₛₜₑₚ is set in the beginning of a pause period when the fade starts and updated whenever a new target ITD is received in accordance with:

$${ITD}_{step} = \frac{{ITD}_{target} - {ITD}_{prev}}{{L}_{xfade} - itd\_xfade \_counter} .$$

The subject matter described herein may be implemented in hardware, software, firmware, or any combination thereof. As such, the terms “function” “node” or “engine” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of a DTX system;

FIG. 2 is a signal diagram illustrating CNG parameter encoding and transmission;

FIG. 3 is a signal diagram illustrating a VAD (or DTX) hangover period;

FIG. 4 is a block diagram of a parametric stereo encoder according to some embodiments;

FIG. 5 is a block diagram of a parametric stereo decoder according to some embodiments;

FIG. 6 is an illustration of ITD according to some embodiments;

FIG. 7 is a signal diagram illustrating ITD delay according to some embodiments;

FIG. 8 is a graphical representation of the coding modes designated by a VAD decision mechanism in accordance with some embodiments;

FIG. 9 is a graph illustrating an example of ITD synthesis when an indicator indicates that foreground and background signals are not efficiently separated during active decoding in accordance with some embodiments;

FIG. 10 is a block diagram of a decoder in accordance with some embodiments;

FIG. 11 is a block diagram of a virtualization environment in accordance with some embodiments;

FIG. 12 is a flow chart illustrating a process for synthesizing stereo signals a decoder according to some embodiments; and

FIG. 13 is a flow chart illustrating a process for gradually fading an ITD used for stereo upmix at a decoder according to some embodiments.

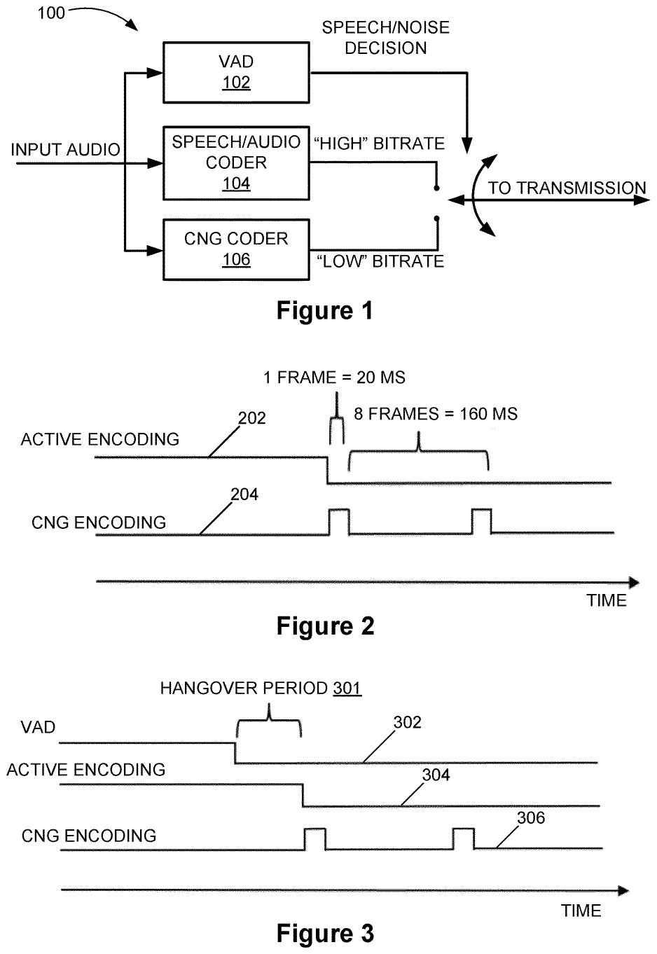

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

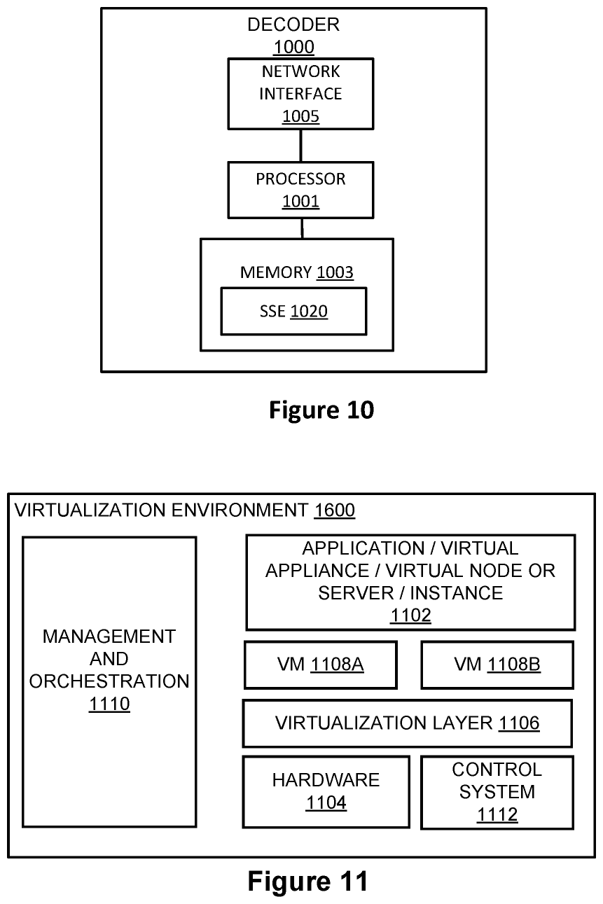

As indicated above, embodiments of the disclosed subject matter pertain to adapting the smoothing of one or more stereo parameters for comfort noise generation (CNG) depending on whether or not the coding of active frames can efficiently separate the spatial properties of the foreground signals from the background signals. For example, the disclosed subject matter may comprise a decoder and/or an improved stereo synthesis engine (SSE) (as described in more detail below and depicted in FIG. 10) that is configured to vary the application of stereo parameters (such as ITD) during CNG depending on whether or not the coding of active frames may separate the spatial properties (e.g., position) of the foreground (e.g., speech) and background signals. Such techniques may be beneficial when decoding speech and/or music.

In scenarios where the coding of active frames cannot efficiently separate the spatial properties of foreground and background signals (e.g., when residual coding is not applied), a smooth transition of the stereo parameters going from active coding to inactive coding (e.g., CNG) may be applied. After new stereo parameter estimates are received (via SID frames), the rate of the transition can be updated. For subsequent stereo parameter updates, a faster (e.g., immediate) change in synthesized stereo parameters may be applied.

Conversely, in scenarios where the coding of active frames can efficiently separate the spatial properties of foreground and background signals (e.g., when residual coding is applied), a sudden transition of the stereo parameters going from active coding to inactive coding (e.g., CNG) may be applied.

In some embodiments, the disclosed decoder and/or its stereo synthesis engine (SSE) is configured to perform a stereo upmix with stereo parameter synthesis. As foreground signals (e.g., speech) and background signals can have different spatial properties, it is important to consider how adequate a codec (e.g., the SSE) can respectively separate these properties during active and inactive coding (e.g., CNG) and based on this, adapt the CNG when transitioning between active coding and inactive coding. While the disclosed subject matter described herein relates to utilizing the ITD value and/or parameter, it is understood that the disclosed methods may be applied to one or more other stereo parameters by the disclosed decoder and/or its stereo synthesis engine without departing from the scope of the disclosed subject matter.

For parametric coding techniques, there typically is signal delay alignment based on the estimated ITD value prior to downmixing into a mono signal in the encoder. At the decoder and/or its stereo synthesis engine, the signals of the audio channels can be shifted in relation to each other such that the desired ITD is obtained.

If the ITD value of the background signal differs from the ITD value of the speech signal, it is likely that the spatial position of the background signal will be impacted by the ITD of the speech during the active coding while the encoder is operating in a parametric coding mode. This means that the position of the background signal may move towards the position of the speech signal, since a change in ITD can be perceived as a change in spatial position. During the transition to CNG (e.g., where the speech signal is not present), the ITD estimate should change to reflect the ITD and spatial position of the background signal.

In an attempt to avoid annoying abrupt and/or sudden transitions from the position of the background signal during active coding that is affected by the ITD of the active (e.g., speech) signal, the ITD can be smoothed by the disclosed decoder and/or its stereo synthesis engine thereby allowing the transitioning of the position of the background signal to be less noticeable while going from active coding to CNG. After new ITD estimates are received (e.g., in SID frames) during this transition, the rate of the transition may be adapted. For subsequent ITD updates, a faster (e.g., immediate) change in the synthesized ITD may be allowed.

However, when there is also residual coding existing on top of the parametric coding for active frames, the decoder codec (e.g., the SSE) may be able to successfully separate the position of the foreground signal (e.g., speech) from the background signal due to that residual coding. In such scenarios, it is important to promptly switch to the correct ITD of the background signal. Keeping an ITD estimate that is heavily impacted by the speech signal may suddenly transfer the spatial position of the background signal towards the position of the speech signal, which may be perceived by a listener as unnatural and/or distracting. To alleviate this problematic issue, a responsive estimation of the ITD may be conducted on the encoder side (e.g., using one or more ITD estimation methods).

In some embodiments, the disclosed decoder and/or its stereo synthesis engine is configured to initially determine whether or not active coding modes may efficiently separate the foreground signals from the background signals with respect to the spatial properties of a stereo parameter, such as the ITD. For example, the disclosed decoder and/or SSE may utilize an indicator or flag to make such a determination.

For example, one such indicator is whether residual coding is applied or not (e.g., the indicator may have a value of “1” if residual coding has been applied, or a value of “0” if residual coding has not been applied). This indicator may also be applicable for other stereo parameters. In some embodiments, the indicator may include a flag or bit value that can be read by the decoder. Further, the indicator value or status may be determined by parsing the bit stream received by the decoder and/or SSE. In some embodiments, the indicator (e.g., which indicates whether residual coding is applied or not) may also be determined directly or indirectly by other parameters or properties of the decoded bitstream, e.g., based on the bitrate and encoding mode. If the decoder and/or codec is configured to utilize residual coding for certain specified bitrates (and/or configured to never utilize residual coding for other bitrates), there is no need for explicit signaling of whether residual coding is applied or not, but the indicator may be determined from the bitrate instead.

When the indicator indicates that the foreground signals and background signals are efficiently separated during active encoding, an ITD (i.e., ITD_{syn}) used for stereo upmix may be determined directly from a target ITD that is obtained from the encoder such that:

$${ITD}_{syn} = {ITD}_{target}$$

When the indicator indicates (as determined by the SSE) that the foreground signals and background signals are not efficiently separated during active encoding, the ITD used for the stereo upmix (i.e., ITD_{syn}) is gradually faded from the previous ITD (i.e., ITDₚᵣₑᵥ) towards ITD_{target} as follows:

$${ITD}_{syn} = {ITD}_{prev} + {ITD}_{step} if itd\_xfade \_counter < {L}_{xfade}$$

where itd_xfade_counter is a frame counter increased by a value of one (1) for every frame during the CNG, L_{xfade} corresponds to a total fade length, and ITDₚᵣₑᵥ keeps track of the most recent ITD value of the gradual fade towards ITD_{target}. For example, in the first frame of the fade, ITDₚᵣₑᵥ may be set to the ITD of the most recent actively encoded frame. As used herein, fade and/or fading refers to the smooth transition of a parameter from a start value towards an end value and/or a target value in a finite number of steps.

In some embodiments, the ITD value may be synthesized by the disclosed decoder and/or its stereo synthesis engine once per frame, or in frequency subbands if there are subband ITD estimates.

In some embodiments, the ITD step is set at the beginning of the CNG period (e.g., when the fade starts) and updated whenever a new target ITD value is received (i.e., in the SID frames). For example, the ITD step can be determined as follows:

$${ITD}_{step} = \frac{{ITD}_{t a rget} - {ITD}_{prev}}{{L}_{xfade} - itd\_xfade \_counter}$$

where L_{xfade} corresponds to the total fade length. By subtracting itd_xfade_counter from L_{xfade}, the total length is fixed while the rate may change when a new ITD target is received. Alternatively, a new fade of length L_{xfade} may start whenever a new ITD target is received. In yet another alternative embodiment, the step length |TDₛₜₑₚ| may be kept constant. Notably, the step length should be kept rather small. Alternatively, the fade length can be kept rather long, thereby making the change of spatial characteristics less noticeable. However, the change of spatial characteristics should not occur too slowly as this may cause the spatial characteristics of the background signal (e.g., spatial position in the case of ITD) to be incorrect with respect to the estimated ITD for a longer time, which may not be desirable. In some embodiments, a suitable value of L_{xfade} would be 100 frames.

If there is any active coding that interrupts the fade period, the ITD may be switched by the disclosed decoder and/or its stereo synthesis engine to the most recently received ITD estimate. However, if the period of active coding is short in length, the fade may continue from its last point before the segment of active encoding ITDₚᵣₑᵥ. In contrast, if there is a longer segment of active coding, the remainder of the fade period can be skipped and the ITD synthesis performed by the disclosed subject matter may be based on the most recent ITD target, i.e.,

$${ITD}_{syn} = {ITD}_{target} if active\_frame \_counter > STEREO\_DFT \_ITD \_CNG \_XFADE \_RESET$$

where active_frame_counter is a counter that indicates the number of active frames. In some embodiments, the threshold STEREO_DFT_ITD_CNG_XFADE_RESET represents a threshold that indicates how many frames are required before a reset is made by the disclosed subject matter. For example, the threshold may be as low as 1-2 frames, but could also be larger to require a longer segment of active coding before the fade is terminated.

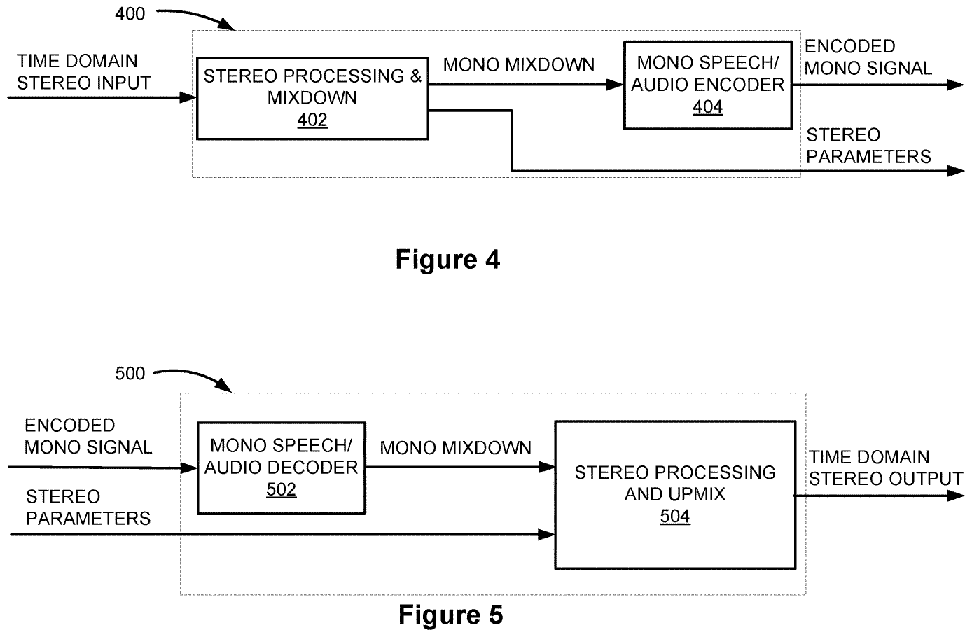

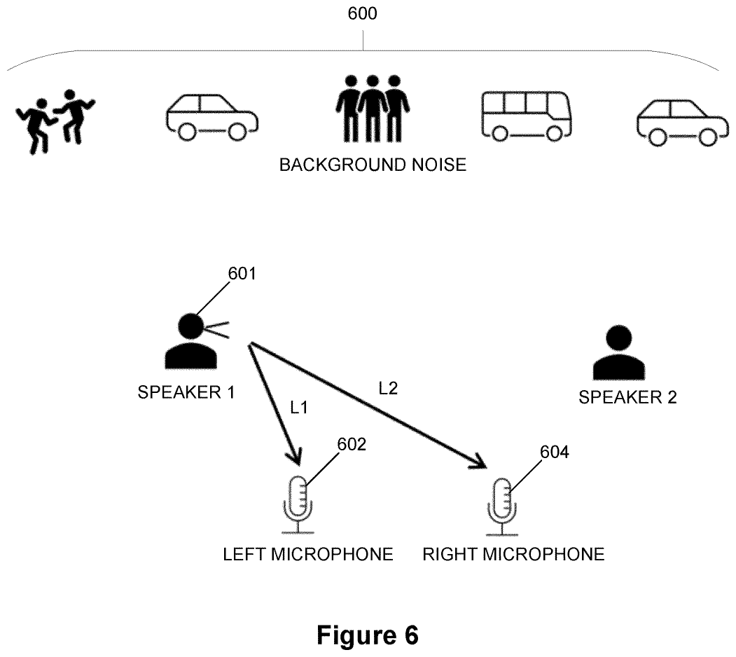

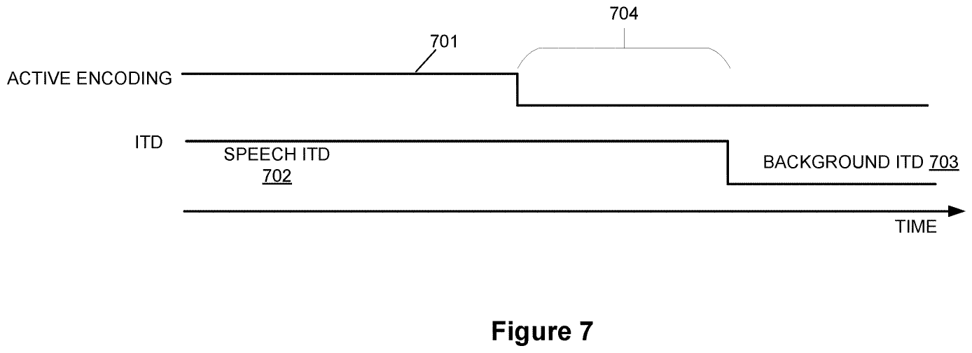

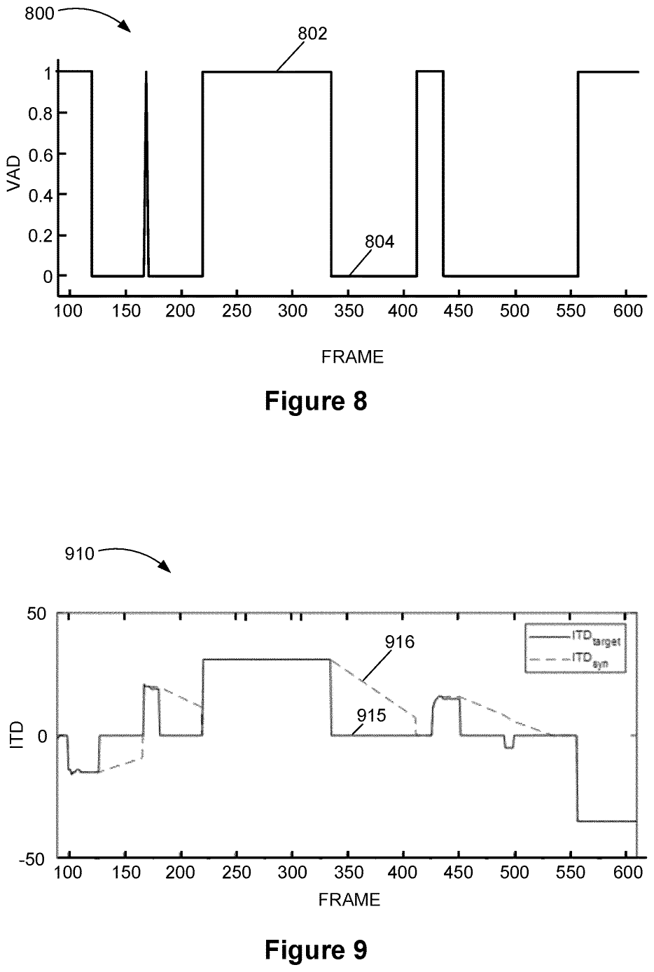

FIGS. 8 and 9 collectively illustrate an example of ITD synthesis conducted by the disclosed decoder and/or its stereo synthesis engine when an indicator indicates that foreground and background signals are not efficiently separated during active encoding. For example, FIG. 8 illustrates a graphical representation of the coding modes designated by a VAD decision mechanism (which may be part of the encoder 400 depicted in FIG. 4) where a “0” value/level in graph 800 denotes inactive frames and a “1” value/level denotes active frames. Notably, FIG. 8 shows an example scenario where there are utterances (or active content) of different duration from slightly different positions. For example, active frame portion 802 indicates a section of audio (e.g., speech audio) of approximately 120 frames in duration that has been designated by VAD as active content (i.e., active coding mode used). Likewise, inactive frame portion 804 indicates a section of audio of approximately 80 frames in duration that has been designated by VAD as CNG background signals/noise (i.e., inactive coding mode used).

FIG. 9 illustrates a plot that overlays plot line values for ITD_{target} and ITD_{syn}. Notably, plot 910 depicts the plot line 916 for ITD_{syn} that is faded towards ITD_{target} (see, e.g., plot line 915). While the ITD_{target} represents the ITD estimate from the encoder side, ITD_{syn} represents the ITDᵥₐₗᵤₑ that may be used by the SSE for stereo upmix. As can be seen in FIG. 9, in the transitions from active coding (VAD being at “1”) and CNG (VAD being “0”) there is a fading of ITD syn towards ITD_{target} which may be aborted by a segment of active coding where ITD syn is directly set to the value of ITD_{target}. The figure also shows that the target ITDᵥₐₗᵤₑ for the fade may change by and updated ITD_{target}. It should also be noted that there is a timing difference between the switches in VAD being “0” or “1” and in the corresponding transitions in ITD_{target}. These timing differences are caused by the ITD estimation and the use of VAD hangover. The fading of ITD_{syn} towards ITD_{target} affords an improved user experience as compared to directly applying ITD_{target} in the SSE stereo upmix when an indicator indicates that foreground and background signals are not efficiently separated during active encoding.

Prior to describing operations from the perspective of the decoder 1000, FIG. 10 is a block diagram illustrating elements of the decoder 1000 configured to decode audio frames according to the various embodiments herein. In some embodiments, decoder 1000 includes at least the same modules contained in decoder 1000 as described above and depicted in FIG. 5. For example, although not shown, decoder 1000 may include a mono speech/audio decoder module and a stereo processing and upmix module among other functionalities and modules.

As shown, decoder 1000 may include a network interface circuitry 1005 (also referred to as a network interface) configured to provide communications with other devices/entities/functions/etc. The decoder 1000 may also include a processing circuitry 1001 (also referred to as a processor or processor circuits) coupled to the network interface circuit 1005, and a memory circuitry 1003 (also referred to as memory) coupled to the processing circuit. The memory circuitry 1003 may include computer readable program code that when executed by the processing circuitry 1001 causes the processing circuit to perform operations according to embodiments disclosed herein.

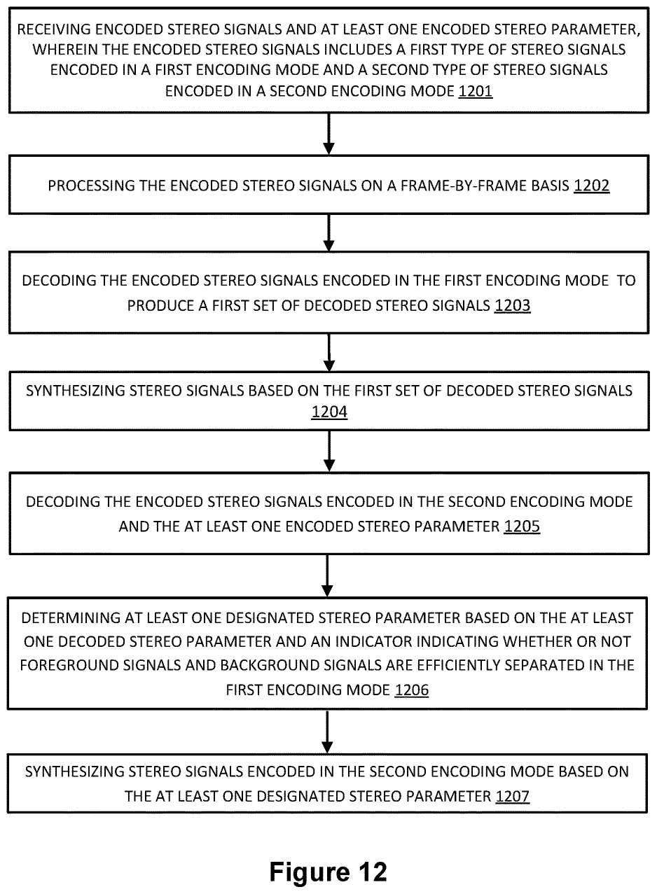

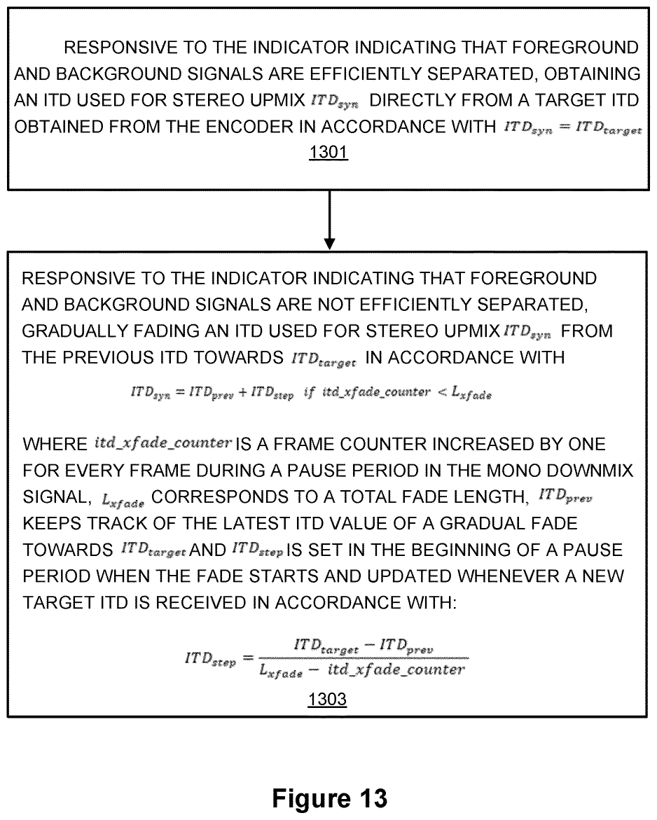

According to other embodiments, processing circuitry 1001 may be defined to include memory so that a separate memory circuit is not required. As discussed herein, operations of the decoder 1000 may be performed by processor 1001 and/or network interface 1005. For example, processing circuitry 1001 may control network interface circuitry 1005 to receive communications from encoder 400. Moreover, modules may be stored in memory 1003, and these modules may provide instructions so that when instructions of a module are executed by processing circuitry 1001, processing circuitry 1001 performs respective operations. In some embodiments, stereo synthesis engine (SSE) 1020 is a software program and/or module that is stored in memory 1003 and is configured to perform the functionalities described herein. For example, stereo synthesis engine 1020 may be utilized to perform the steps described in FIGS. 12-13 below when executed by processing circuitry 1001. In some embodiments, stereo synthesis engine 1020 may be configured to perform the mono speech/audio decoding and stereo processing and upmix functionalities executed by modules 502 and 504 in FIG. 5.

The decoder 1000 may be virtualized in some embodiments by distributing the decoder 1000 across various components. FIG. 11 is a block diagram illustrating an example of a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108A and 1108B (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

Operations of the decoder 1000 (e.g., which may be implemented using the structure of the block diagram of FIGS. 5 and 10) will now be discussed with reference to the flow chart of FIGS. 12-13 according to some embodiments of inventive concepts. For example, one or more modules may be stored in memory 1003 of FIG. 10, and these modules may provide instructions so that when the instructions of a module are executed by respective decoder processing circuitry 1001, the decoder 1000 performs respective operations of the flow chart. In some embodiments, the module stored in memory 1003 may be stereo synthesis engine 1020 (as illustrated in FIG. 10).

FIG. 12 is a flow chart illustrating a process for synthesizing stereo signals a decoder according to some embodiments. Turning to FIG. 12, in block 1201, the decoder 1000 and/or stereo synthesis engine 1020 receives encoded stereo signals and at least one encoded stereo parameter. Further, the encoded stereo signals may include stereo signals encoded in a first encoding mode and stereo signals encoded in a second encoding mode. In some embodiments, the packets of the encoded audio frames may be individually received (one by one) at the decoder. Notably, over time the audio frames encoded in the received packets will be encoded in different modes as well as representing different types of signals.

In block 1202, the decoder 1000 and/or SSE 1020 may process the encoded stereo signals on a frame-by-frame basis. In block 1203, the decoder 1000 and/or SSE 1020 may be configured to decode the encoded stereo signals encoded in the first encoding mode to produce a first set of decoded stereo signals.

In block 1204, the decoder 1000 and/or SSE 1020 may synthesize stereo signals based on the first set of decoded stereo signals. In block 1205, the decoder 1000 and/or SSE 1020 may decode the encoded stereo signals encoded in the second encoding mode and the at least one encoded stereo parameter.

In block 1206, the decoder 1000 and/or SSE 1020 may determine at least one designated stereo parameter based on the at least one decoded stereo parameter and an indicator indicating whether or not foreground signals and background signals are efficiently separated in the first encoding mode. In block 1207, the decoder 1000 and/or SSE 1020 may be configured to synthesize stereo signals encoded in the second encoding mode based on the at least one designated stereo parameter.

FIG. 13 is a flow chart illustrating a process for gradually fading an ITD used for stereo upmix at a decoder according to some embodiments. For example, as illustrated in FIG. 13, the at least one stereo parameter is an inter-channel time difference (ITD) value and in block 1301, the decoder 1000 and/or stereo synthesis engine 1020 estimates the ITDᵥₐₗᵤₑ by, responsive to the indicator indicating that foreground and background signals are efficiently separated, obtaining an ITDᵥₐₗᵤₑ used for stereo upmix ITD_{syn} directly from a target ITD obtained from the encoder in accordance with

$${ITD}_{syn} = {ITD}_{target} .$$

In block 1303, the decoder 1000 and/or stereo synthesis engine 1020, responsive to the indicator indicating that foreground and background signals are not efficiently separated, gradually fades an ITD used for stereo upmix ITD_{syn} from the previous ITD towards ITD_{target} in accordance with:

$${ITD}_{syn} = {ITD}_{preν} + {ITD}_{step} if itd\_xfade \_counter < {L}_{xfade}$$

where itd_xfade_counter is a frame counter increased by one for every frame during a pause period in the mono downmix signal, L_{xfade} corresponds to a total fade length, ITDₚᵣₑᵥ keeps track of the latest ITDᵥₐₗᵤₑ of a gradual fade towards ITD_{target}, and ITDₛₜₑₚ is set in the beginning of a pause period when the fade starts and updated whenever a new target ITD is received in accordance with:

$${ITD}_{step} = \frac{{ITD}_{target} - {ITD}_{prev}}{{L}_{xfade} - itd\_xfade \_counter}$$

where L_{xfade} corresponds to a total fade length.

Although the computing devices described herein (e.g., encoders, decoders, UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method to adjust at least one stereo parameter in a decoder, the method comprising:
receiving encoded stereo signals and at least one stereo parameter, wherein the encoded stereo signals includes stereo signals encoded in a first encoding mode and stereo signals encoded in a second encoding mode;
processing the encoded stereo signals on a frame-by-frame basis;
decoding the encoded stereo signals encoded in the first encoding mode to produce a first set of decoded stereo signals;
synthesizing stereo signals based on the first set of decoded stereo signals;
decoding the encoded stereo signals encoded in the second encoding mode and the at least one stereo parameter;
determining at least one designated stereo parameter based on the at least one decoded stereo parameter and an indicator indicating whether or not foreground signals and background signals are efficiently separated in the first encoding mode; and
synthesizing stereo signals encoded in the second encoding mode based on the at least one designated stereo parameter.

2. The method of claim 1, wherein the decoding the encoded stereo signals encoded in a second encoding mode and the at least one stereo parameter comprises decoding an encoded mono downmix signal.

3. The method of claim 2, wherein the at least one stereo parameter comprises an inter-channel time difference, ITD.

4. The method of claim 3, wherein determining the ITD comprises:
responsive to the indicator indicating that foreground and background signals are efficiently separated, obtaining an ITD used for stereo upmix ITD_{syn} directly from a target ITD obtained from the encoder in accordance with ITD_{syn}=ITD_{target}.

5. The method of claim 3, wherein determining the ITD further comprises:
responsive to the indicator indicating that foreground and background signals are not efficiently separated, gradually fading an ITD used for stereo upmix ITD_{syn} from the previous ITD towards ITD_{target} in accordance with:
$${ITD}_{syn} = {ITD}_{prev} + {ITD}_{step} if itd\_xfade \_counter < {L}_{xfade}$$
wherein itd_xfade_counter is a frame counter increased by one for every frame during a pause period in the mono downmix signal, L_{xfade} corresponds to a total fade length, ITDₚᵣₑᵥ keeps track of the latest ITDᵥₐₗᵤₑ of a gradual fade towards ITD_{target} and ITDₛₜₑₚ is set in the beginning of a pause period when the fade starts and updated whenever a new target ITD is received in accordance with:
$${ITD}_{step} = \frac{{ITD}_{target} - {ITD}_{prev}}{{L}_{xfade} - itd\_xfade \_counter} .$$

6. A decoder adapted to perform operations comprising:
receiving encoded stereo signals and at least one encoded stereo parameter, wherein the encoded stereo signals includes a first type of stereo signals encoded in a first encoding mode and a second type of stereo signals encoded in a second encoding mode;
processing the encoded stereo signals on a frame-by-frame basis;
decoding the encoded stereo signals encoded in the first encoding mode to produce a first set of decoded stereo signals;
synthesizing stereo signals based on the first set of decoded stereo signals;
decoding the encoded stereo signals encoded in the second encoding mode and the at least one encoded stereo parameter;
determining at least one designated stereo parameter based on the at least one decoded stereo parameter and an indicator indicating whether or not foreground signals and background signals are efficiently separated in the first encoding mode; and
synthesizing stereo signals encoded in the second encoding mode based on the at least one designated stereo parameter.

7. The decoder of claim 6, wherein the decoding the encoded stereo signals encoded in a second encoding mode and the at least one stereo parameter comprises decoding an encoded mono downmix signal.

8. The decoder of claim 7, wherein the at least one stereo parameter comprises an inter-channel time difference, ITD.

9. The decoder of claim 8, wherein determining the ITD comprises:
responsive to the indicator indicating that foreground and background signals are efficiently separated, obtaining an ITD used for stereo upmix ITD_{syn} directly from a target ITD obtained from the encoder in accordance with ITD_{syn}=ITD_{target}.

10. The decoder of claim 8, wherein determining the ITD further comprises:
responsive to the indicator indicating that foreground and background signals are not efficiently separated, gradually fading an ITD used for stereo upmix ITD_{syn} from the previous ITD towards ITD_{target} in accordance with:
$${ITD}_{syn} = {ITD}_{prev} + {ITD}_{step} if itd\_xfade \_counter < {L}_{xfade}$$
wherein itd_xfade_counter is a frame counter increased by one for every frame during a pause period in the mono downmix signal, L_{xfade} corresponds to a total fade length, ITDₚᵣₑᵥ keeps track of the latest ITDᵥₐₗᵤₑ of a gradual fade towards ITD_{target} and ITDₛₜₑₚ is set in the beginning of a pause period when the fade starts and updated whenever a new target ITD is received in accordance with:
$${ITD}_{step} = \frac{{ITD}_{target} - {ITD}_{prev}}{{L}_{xfade} - ifd\_xfade \_counter} .$$

11. A decoder comprising:
processing circuitry; and
memory coupled with the processing circuitry, wherein the memory includes instructions that when executed by the processing circuitry causes the decoder to perform operations comprising:
receiving encoded stereo signals and at least one encoded stereo parameter, wherein the encoded stereo signals includes a first type of stereo signals encoded in a first encoding mode and a second type of stereo signals encoded in a second encoding mode;
processing the encoded stereo signals on a frame-by-frame basis;
decoding the encoded stereo signals encoded in the first encoding mode to produce a first set of decoded stereo signals;
synthesizing stereo signals based on the first set of decoded stereo signals;
decoding the encoded stereo signals encoded in the second encoding mode and the at least one encoded stereo parameter;
determining at least one designated stereo parameter based on the at least one decoded stereo parameter and an indicator indicating whether or not foreground signals and background signals are efficiently separated in the first encoding mode; and
synthesizing stereo signals encoded in the second encoding mode based on the at least one designated stereo parameter.

12. The decoder of claim 11, wherein the decoding the encoded stereo signals encoded in a second encoding mode and the at least one stereo parameter comprises decoding an encoded mono downmix signal.

13. The decoder of claim 12, wherein the at least one stereo parameter comprises an inter-channel time difference, ITD.

14. The decoder of claim 13, wherein the memory includes further instructions that when executed by the processing circuitry causes the decoder to perform operations including determining the ITD that comprises:
responsive to the indicator indicating that foreground and background signals are efficiently separated, obtaining an ITD used for stereo upmix ITD_{syn} directly from a target ITD obtained from the encoder in accordance with ITD_{syn}=ITD_{target}.

15. The decoder of claim 14, wherein determining the ITD further comprises:
responsive to the indicator indicating that foreground and background signals are not efficiently separated, gradually fading an ITD used for stereo upmix ITD_{syn} from the previous ITD towards ITD_{target} in accordance with:
$${ITD}_{syn} = {ITD}_{prev} + {ITD}_{step} if itd\_xfade \_counter < {L}_{xfade}$$
wherein itd_xfade_counter is a frame counter increased by one for every frame during a pause period in the mono downmix signal, L_{xfade} corresponds to a total fade length, ITDₚᵣₑᵥ keeps track of the latest ITDᵥₐₗᵤₑ of a gradual fade towards ITD_{target} and ITDₛₜₑₚ is set in the beginning of a pause period when the fade starts and updated whenever a new target ITD is received in accordance with:
$${ITD}_{step} = \frac{{ITD}_{target} - {ITD}_{prev}}{{L}_{xfade} - itd\_xfade \_counter} .$$

16.-20. (canceled)

21. A computer program product comprising a non-transitory computer readable storage medium having program code, to be executed by processing circuitry of a decoder, whereby execution of the program code causes the decoder to perform operations comprising:
receiving encoded stereo signals and at least one encoded stereo parameter, wherein the encoded stereo signals includes a first type of stereo signals encoded in a first encoding mode and a second type of stereo signals encoded in a second encoding mode;
processing the encoded stereo signals on a frame-by-frame basis;
decoding the encoded stereo signals encoded in the first encoding mode to produce a first set of decoded stereo signals;
synthesizing stereo signals based on the first set of decoded stereo signals;
decoding the encoded stereo signals encoded in the second encoding mode and the at least one encoded stereo parameter;
determining at least one designated stereo parameter based on the at least one decoded stereo parameter and an indicator indicating whether or not foreground signals and background signals are efficiently separated in the first encoding mode; and
synthesizing stereo signals encoded in the second encoding mode based on the at least one designated stereo parameter.

22. The computer program product of claim 21, wherein the decoding the encoded stereo signals encoded in a second encoding mode and the at least one stereo parameter comprises decoding an encoded mono downmix signal.

23. The computer program product of claim 22, wherein the at least one stereo parameter comprises an inter-channel time difference, ITD.

24. The computer program product of claim 23, wherein the non-transitory computer readable storage medium has further program code, to be executed by processing circuitry of the decoder, whereby execution of the program code causes the decoder to perform an operations that comprises:
responsive to the indicator indicating that foreground and background signals are efficiently separated, obtaining an ITD used for stereo upmix ITD_{syn} directly from a target ITD obtained from the encoder in accordance with ITD_{syn}=ITD_{target}.

25. The computer program product of claim 23, wherein determining the ITD further comprises:
responsive to the indicator indicating that foreground and background signals are not efficiently separated, gradually fading an ITD used for stereo upmix ITD_{syn} from the previous ITD towards ITD_{target} in accordance with:
$${ITD}_{syn} = {ITD}_{prev} + {ITD}_{step} if itd\_xfade \_counter < {L}_{xfade}$$
wherein itd_xfade_counter is a frame counter increased by one for every frame during a pause period in the mono downmix signal, L_{xfade} corresponds to a total fade length, ITDₚᵣₑᵥ keeps track of the latest ITDᵥₐₗᵤₑ of a gradual fade towards ITD_{target} and ITDₛₜₑₚ is set in the beginning of a pause period when the fade starts and updated whenever a new target ITD is received in accordance with:
$${ITD}_{step} = \frac{{ITD}_{target} - {ITD}_{preν}}{{L}_{xfade} - itd\_xfade \_counter} .$$
